(19) United States
(12) Patent Application Publication
(10) Pub. No.: US 2010/0190455 A1
(43) Pub. Date: Jul. 29, 2010

(54) Network-type light emitting diode illuminating lamp which can perform wireless communication

(75) Inventor: Kenjiro Hashizume, Osaka (JP)

Correspondence Address: Yashima Dengyo Co., Ltd., P.O Box No. 6-57, Junghe,, Taipei, 235, TW

(73) Assignee: Yashima Dengyo Co., Ltd., Osaka (JP)

(21) Appl. No.: 12/320,395

(22) Filed: Jan. 26, 2009

(51) Int. Cl. H04B 1/38; H05B 41/36

(52) U.S. Cl. 455/90.3; 315/291

(57) ABSTRACT

A network-type light emitting diode (LED) illuminating lamp which performs wireless communication, includes terminal blocks, a lamp chamber, power conversion units, a control unit, a substrate and LEDs. Each terminal block includes a first and second pole. The lamp chamber includes a holding space. Each power conversion unit is electrically connected the first and second pole of each terminal block, to convert an AC current into a DC current. The control unit is electrically connected with one power conversion unit and includes a microcomputer, a driver circuit, a network module and a wireless communication element. The substrate is in the lamp chamber and is electrically connected with the power conversion units and the control unit. The LEDs are implanted on the substrate. Thus, through equipment like a personal computer, control instructions are outputted to control brightness and power consumption of many LED illuminating equipment, forming an energy-saving smart-type illuminating environment.

### BACKGROUND OF THE INVENTION

a) Field of the Invention

The present invention relates to a light emitting diode illuminating lamp, and more particularly to a network-type light emitting diode illuminating lamp which can perform wireless communication. The light emitting diode illuminating lamp utilizes a control unit to control a substrate which is implanted with light emitting diodes to output a plurality of control instructions through equipment such as a computer, for controlling brightness and power consumption of more than one LED (light emitting diode) illuminating equipment, thereby constructing an energy-saving smart-type illuminating environment.

b) Description of the Prior Art

The Taiwanese New Utility Patent No. M344439 discloses an LED light tube structure, wherein a plurality of LEDs are implanted on a fixed light panel, along with a lamp holder and a lamp shade, to form an LED light tube structure which is provided with a shape of a conventional fluorescent lamp, for being applied to the lamp holder of the conventional fluorescent lamp.

Another Taiwanese Invention Patent No. 200835881 discloses an LED lamp-set device which can be used to replace directly a fluorescent tube, wherein two sides of the lamp-set are installed respectively with a terminal block, and an interior of the light tube is provided with a switch circuit to convert an alternate current (AC) into a directly current (DC) used by the LED.

Although the aforementioned LED light tubes can all be used for the conventional fluorescent lamp holder, a status of the LED cannot be controlled through wireless communication, such as an on/off state of the LED, brightness of the LED, and power consumption of the LED. In addition, a specific group of LED lamp-sets cannot be controlled synchronously through network communication, and light of the LED lamp-sets cannot be utilized to construct visible light network communication, either.

### SUMMARY OF THE INVENTION

The primary object of the present invention is to solve the problem that the specific parameters of the LED lamp-set cannot be controlled by the wireless communication technology, the problem that the LED lamp-sets cannot be installed in groups and controlled synchronously through the network communication, as well as the problem that the light of the LED lamp-set cannot be used to perform the visible light network communication.

The present invention provides a network-type LED illuminating lamp which can perform wireless communication, including terminal blocks, a lamp chamber, power conversion units, a control unit, a substrate and LEDs, wherein each terminal block is provided with a first pole and a second pole; the lamp chamber is provided with a holding space; each power conversion unit is electrically connected with the first pole and the second pole of each aforementioned terminal block, to convert an AC current into a DC current; the control unit is electrically connected with one of the aforementioned power conversion units, and is provided with a microcomputer, a driver circuit, a network module and a wireless communication element; the substrate is provided in the lamp chamber, and is electrically connected with the power conversion units and the control unit; and the LEDs are implanted on the substrate.

The present invention further includes a complex router, and the aforementioned control unit is wirelessly connected with the complex router through the wireless communication element.

The aforementioned complex router is built in with or connected with a wireless communication module which uses a same communication protocol as that the aforementioned wireless communication element does. The communication protocol is the Zigbee communication technology (a short range, low speed and low power consumption wireless communication technology), the Wi-Fi communication technology or the Wi-Max communication technology.

The aforementioned control unit is provided in or out of the lamp chamber.

The aforementioned control unit transmits ascending (or descending) parameters in segments or without segments to the light emitting diodes, so as to control the brightness or power consumption of the light emitting diodes.

The aforementioned network-type LED illuminating lamp which can perform wireless communication further includes an accumulator unit which is electrically connected with the power conversion units and the control unit.

The aforementioned control unit further connects or includes an environment sensor.

The light produced by the LEDs of the aforementioned network-type LED illuminating lamp which can perform wireless communication is utilized as a signal transmission interface.

The present invention is provided with following advantages:
1. The present invention uses the conventional lamp-set, such as a fluorescent lamp, a light bulb or an energy-saving light bulb, as the structure, and provides the control unit and the LEDs in the lamp-set, allowing the energy-saving LEDs to be applied to the existing conventional lamp holder, thereby largely reducing cost in converting the energy-wasting light source into the energy-saving light source.
2. The present invention combines the complex router. By the complex router, the plural LED illuminating equipment can be constructed as an illuminating group which operates synchronously, and is especially suitable for an office, a factory, a building, a train stations, a shop or a public space.
3. The complex router uses the wireless communication technology (such as the Zigbee technology) to perform the wireless communication with the plural LED illuminating equipment, without providing a connection wiring between the two. Therefore, an installation location of the LED illuminating equipment is not limited easily.
4. The complex router can be connected with a personal computer, a laptop computer, a PDA (personal digital assistant), a smart phone, a local area network or internet. Through the equipment, such as the personal computer, the plural control instructions are outputted to control the brightness, the power consumption or the on/off or the LED illuminating equipment, so as to easily construct an energy-saving smart-type illuminating environment.
5. Through the local area network or the internet, more than one LED illuminating equipment can be controlled locally or remotely.
6. The present invention is provided with the accumulator unit. Therefore, when a disaster or black-out occurs, power can be provided by the accumulator unit, allowing the LED illuminating equipment to continue illuminating to provide an evacuation indication or temporary illumination.
7. The light produced by the LED illuminating equipment is used as a signal transmission interface, and by transmitting data with visible light, any place where the light is available can serve as an area to which the data is transmitted, thereby improving convenience in transmitting the data.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a cutaway view of a lamp chamber of the present invention.

FIG. 2 shows a schematic view of a structure of a control unit, and a schematic view that the control unit is connected wirelessly with a complex router by a wireless communication element, according to the present invention.

FIG. 3 shows a schematic view of the present invention installed in a lamp holder.

FIG. 4 shows a schematic view of the present invention, including a complex router and being connected with a computer.

FIG. 5 shows a schematic view of the present invention, including a plurality of complex routers, and being connected with a computer, a PDA, a laptop computer and internet.

### DETAILED DESCRIPTION OF THE PREFERRED EMBODIMENTS

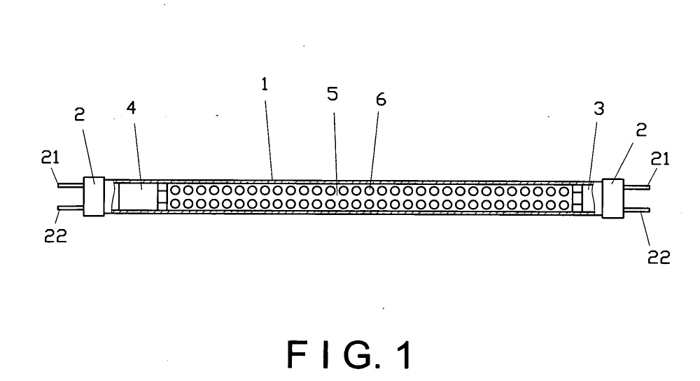

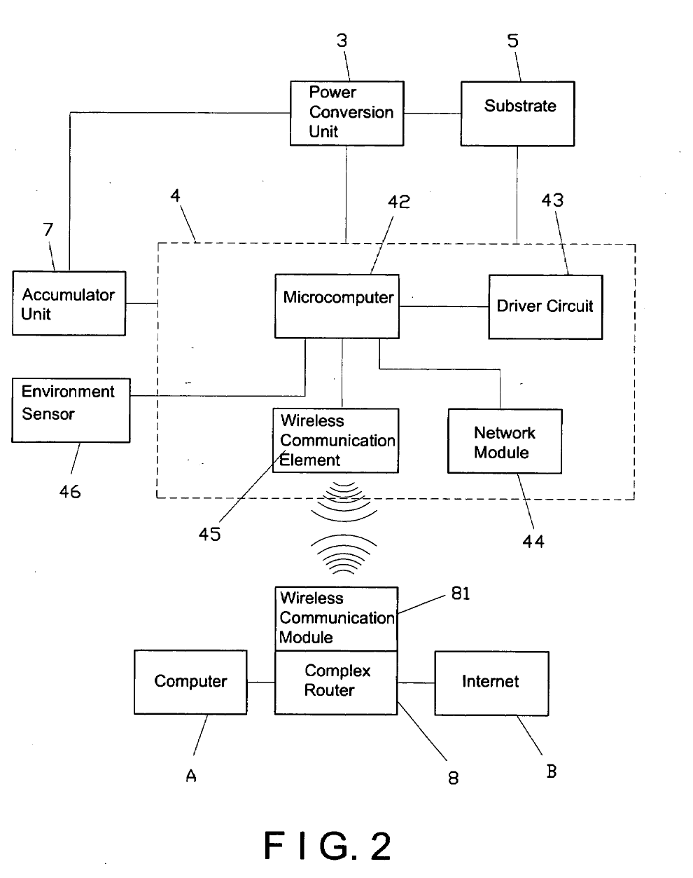

Referring to FIG. 1 and FIG. 2, the present invention, which is implemented to a fluorescent tube as an example, comprises a lamp chamber 1, terminal blocks 2, power conversion units 3, a control unit 4, a substrate 5, light emitting diodes 6, and an accumulator unit 7.

The lamp chamber 1, which is a conventional fluorescent tube in the present embodiment, includes a holding space.

The terminal blocks 2 are provided at two sides of the lamp chamber 1, and each terminal block 2 includes a first pole 21 and a second pole 22.

The power conversion units 3 are provided in or out of the lamp chamber 1 and are located inside the lamp chamber 1 for the present embodiment. Each power conversion unit 3 is electrically connected with the first pole 21 and the second pole 22 of each aforementioned terminal block 2, to convert an AC current into a DC current.

The control unit 4 is provided in or out of the lamp chamber 1 and is located inside the lamp chamber 1 for the present embodiment. The control unit 4 is electrically connected with one of the aforementioned power conversion units 3 and includes at least a microcomputer 42, a driver circuit 43, a network module 44 and a wireless communication element 45. The wireless communication element 45 utilizes a wireless communication technology to perform communication, such as the Zigbee communication technology (a short range, low speed and low power consumption wireless network communication technology), the Wi-Fi communication technology or the Wi-Max communication technology; the present embodiment uses the Zigbee communication technology.

The substrate 5 is provided in the lamp chamber 1 and is electrically connected with the power conversion units 3 and the control unit 4.

The light emitting diodes 6 are implanted on the substrate 5.

The accumulator unit 7 is electrically connected with the power conversion units 3 and the control unit 4.

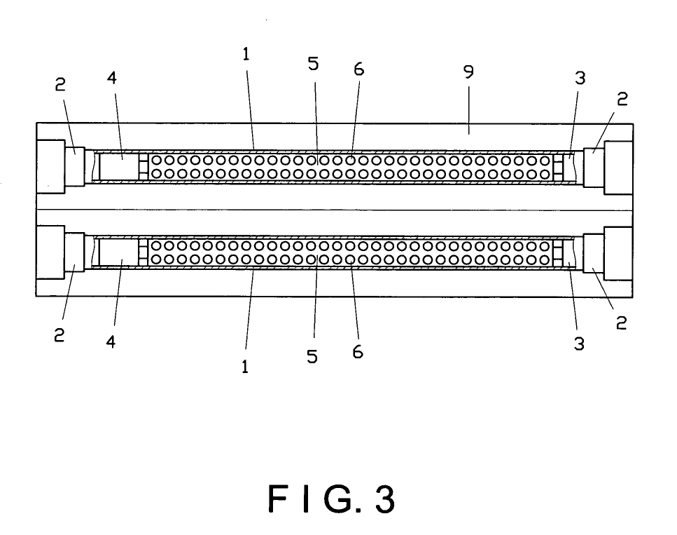

Referring to FIG. 3, as the lamp chamber 1 and the terminal blocks 2 are of same shapes and sizes as those of the conventional fluorescent tube, the present invention can be assembled in a conventional fluorescent lamp holder 9, forming LED illuminating equipment.

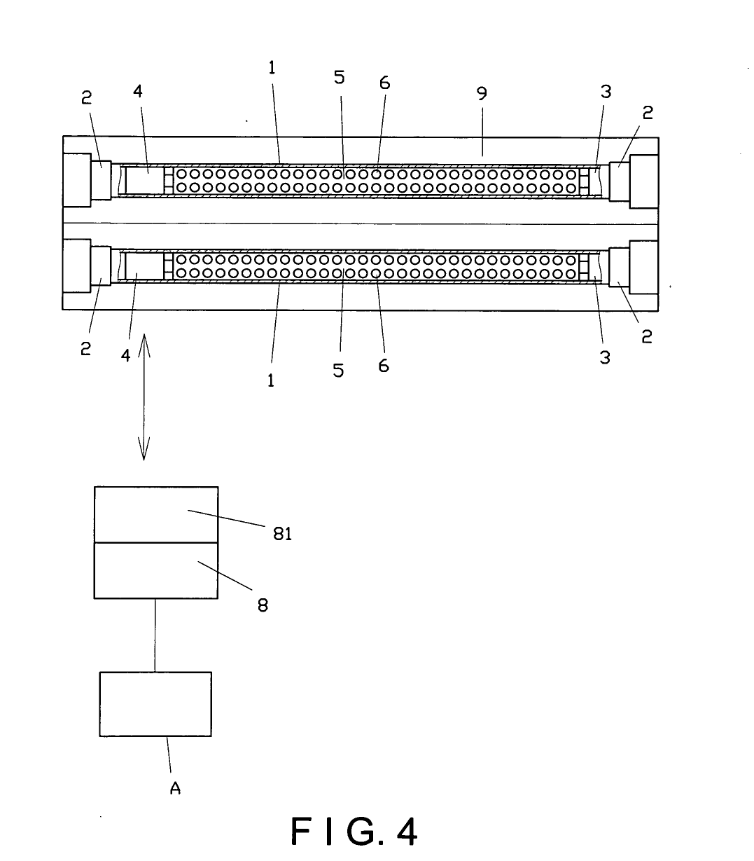

Referring to FIG. 2 and FIG. 4, the present invention further includes a complex router 8. The aforementioned control unit 4 is wirelessly connected with the complex router 8 by the wireless communication element 45, and the complex router 8 is built in with or connected with a wireless communication module 81 which utilizes the same Zigbee communication technology as that the wireless communication element 45 does. The complex router 8 can be connected with a computer A, and then instructions of the computer. A can control the light emitting diodes 6 in the lamp chamber 1, through the complex router 8.

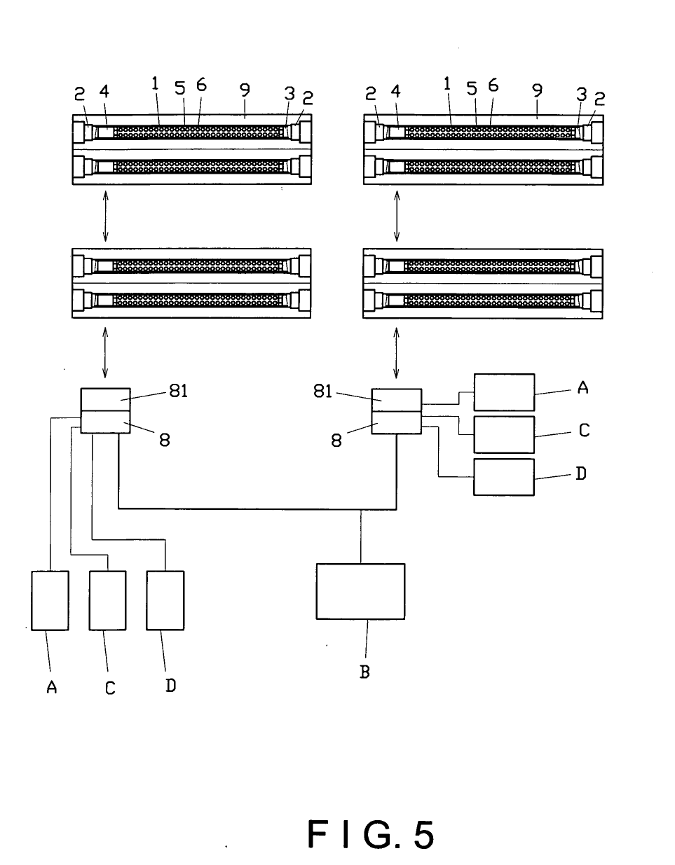

Referring to FIG. 2 and FIG. 5, as the control unit 4 of the present invention includes the wireless communication element 45, and in the mean time, the complex router 8 is also built in with or connected with the wireless communication module 81, with the complex router 8 and the wireless communication module 81 utilizing the same Zigbee communication technology, in an area where wireless signals of the wireless communication module 81 can reach, a plurality of groups of illumination equipment can be commonly connected to one complex router 8, forming a group structure. In addition, as the control unit 4 includes the network module 44, and the complex router 8 can allocate a specific network address to the network module 44; therefore, when a plurality of network modules 44 commonly correspond to one complex router 8, that complex router 8 can allocate a different network address to each network module 44, forming a group of network-type LED illumination equipment. The complex router 8 can be also connected with a computer A, a PDA C, a laptop computer D or internet B. Accordingly, the computer A, the PDA C and the laptop computer D can output control instructions which are transmitted to the wireless communication element 45 of the control unit 4, through the wireless communication module 81 of the complex router 8, and using the Zigbee communication technology, thereby locally or remotely controlling the light emitting diodes 6 in plural lamp chambers 1 to operate synchronously. The control unit 4 can accept the control instructions to transmit ascending or descending parameters in segments or without segments to the light emitting diodes 6, for controlling brightness or power consumption of the light emitting diodes 6. For example, by using the computer A to output the control instructions, the brightness of the light emitting diodes 6 can be controlled in segments as 20%, 40%, 60%, 80% or 100%. Or, by using the computer A to output the ON or OFF control instruction, the on or off of the light emitting diodes 6 can be controlled. In FIG. 5, two complex routers 8 are provided, and each complex router 8 is connected individually with and controls a group of illuminating equipment. When a disaster or a black-out occurs, by electricity accumulated in the accumulator unit 7 of the present invention, power can be provided to the light emitting diodes 6, so as to facilitate serving as an evacuation indication or illuminating in an emergency condition. The control unit 4 of the present invention can be further connected with or include an environment sensor 46 by which environment data, such as temperature, brightness, humidity, content of carbon monoxide and content of smoke, can be collected and transmitted to the computer A, the PDA C, the laptop computer D or the internet B, through the control unit 4 and the complex router 8.

Moreover, the aforementioned embodiment utilizes the fluorescent tube as the implementation configuration. When being implemented to the fluorescent tube, two terminal blocks (each one at two sides of the fluorescent tube) are provided. However, the present invention can be also implemented to other lamp-sets; for example, when being implemented to a light bulb, only one terminal block is provided, but the terminal block still includes the first pole and the second pole.

Light produced by the light emitting diodes 6 of the present invention is used as a signal transmission interface. By transmitting data with visible light, any place where the light reaches can be an area to which data is transmitted, thereby improving convenience in transmitting data.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A network-type light emitting diode illuminating lamp which can perform wireless communication, comprising terminal blocks, a lamp chamber, power conversion units, a control unit, a substrate and light emitting diodes, wherein, each terminal block includes a first pole and a second pole; the lamp chamber is provided with a holding space; each power conversion unit is electrically connected with the first pole and the second pole of each terminal block; the control unit is electrically connected with one of the power conversion units, and is provided with a microcomputer, a driver circuit, a network module and a wireless communication element; the substrate is provided in the lamp chamber and is electrically connected with the power conversion units and the control unit; and the light emitting diodes are implanted on the substrate.

2. The network-type light emitting diode illuminating lamp which can perform wireless communication, according to claim 1, wherein the control unit is further connected wirelessly with a complex router by the wireless communication element.

3. The network-type light emitting diode illuminating lamp which can perform wireless communication, according to claim 2, wherein the complex router is built in with or connected with a wireless communication module which utilizes a same communication protocol as that the wireless communication element of the control unit does, with the communication protocol being the Zigbee communication technology, the Wi-Fi communication technology or the Wi-Max communication technology.

4. The network-type light emitting diode illuminating lamp which can perform wireless communication, according to claim 1, wherein the control unit transmits ascending or descending parameters in segments to the light emitting diodes, so as to control brightness or power consumption.

5. The network-type light emitting diode illuminating lamp which can perform wireless communication, according to claim 1, wherein the control unit transmits ascending or descending parameters without segments to the light emitting diodes, so as to control brightness or power consumption.

6. The network-type light emitting diode illuminating lamp which can perform wireless communication, according to claim 1, further including an accumulator unit which is electrically connected with the power conversion units and the control unit.

7. The network-type light emitting diode illuminating lamp which can perform wireless communication, according to claim 1, wherein the control unit further connects or includes an environment sensor.

8. The network-type light emitting diode illuminating lamp which can perform wireless communication, according to claim 1, wherein light produced by the light emitting diodes is used as a signal transmission interface.
